(19) United States
(12) Patent Application Publication
(10) Pub. No.: US 2013/0034913 A1
(43) Pub. Date: Feb. 7, 2013

(54) Method for Investigating a Specimen Containing Fluorescing Dyes with the Aid of a Microscope

(71) Applicant: LEICA MICROSYSTEMS CMS GMBH, Wetzlar (DE)

(72) Inventors: Volker SEYFRIED, Nussloch (DE); Werner KNEBEL, Kronau (DE)

(73) Assignee: LEICA MICROSYSTEMS CMS GMBH, Wetzlar (DE)

(21) Appl. No.: 13/648,740

(22) Filed: Oct. 10, 2012

Related U.S. Application Data
(63) Continuation of application No. PCT/EP2011/053061, filed on Mar. 2, 2011.

(30) Foreign Application Priority Data
Apr. 23, 2010 (DE) 10 2010 016 598.0

(51) Int. Cl. G01N 21/76

(52) U.S. Cl. 436/172

(57) ABSTRACT

In order to investigate a specimen (30) with the aid of a microscope (20), dye particles (40, 42) in the specimen (30) are excited to fluoresce with the aid of a first illumination light beam (24). Fluorescent light proceeding from the specimen (30) is directed via an optical arrangement (34) onto an areal sensor (36), the optical arrangement (34) acting on the fluorescent light in such a way that sub-beams of the fluorescent light interfere with themselves, so that interference patterns produced as a result of the interference are imaged on a sensitive surface of the areal sensor (36) and sensed thereby. Positions of the dye particles (40, 42) within the specimen (30) are ascertained as a function of the interference patterns.

### FIELD OF THE INVENTION

The invention relates to a method for investigating a specimen containing fluorescing dyes with the aid of a microscope. Dye particles in the specimen are excited to fluoresce with the aid of a first illumination light beam of the microscope. Fluorescent light proceeding from the specimen is directed via an optical arrangement onto an areal sensor.

### BACKGROUND OF THE INVENTION

Three-dimensional structures within a specimen can be visualized in various ways. For example, a two-dimensional region, in particular a plane, on or in the specimen can be scanned with a scanning microscope. Structures perpendicular to the plane can be resolved by, for example, moving a specimen stage, or portions of the optical system of the microscope, parallel to the beams to be detected (hereinafter called detection beams). Mechanical displacement of these components takes a relatively long time, however, and requires a particularly precise and therefore complex design for the microscope that is used.

Alternatively thereto, it is known to resolve structures in the specimen along a direction parallel to the detection beams by the fact that an optical arrangement which causes the detection beams to interfere with themselves is arranged in the detection beam path. The light beams thereby interfered with are then directed onto an areal sensor. Interference patterns form on the areal sensor as a result of the interfering radiation. In the case of point light sources, the interference patterns essentially encompass ring patterns. The location of the light sources within a plane and perpendicular to the plane can then be ascertained on the basis of the interference patterns, so that three-dimensional resolution of the structures in the specimen is possible with no need to move mechanical components of the microscope. One corresponding method is, for example, FINCH.

It is furthermore known to visualize structures in a specimen, for example in a tissue specimen or a living cell, by introducing fluorescing dye particles into the specimen. The dye particles in the specimen are then excited to fluoresce, and the fluorescent light emitted from the specimen is detected. The fluorescing dye particles can participate in different ways in transport processes in the specimen, or can adhere to structures within the specimen, so that the transport processes and structures can be respectively investigated on the basis of the emitted fluorescent light. Suitable dye particles are fluorescent dyes, for example organic dyes, in particular fluorescing proteins and/or tandem molecules, or inorganic dyes such as nanocrystals that are coupled to biomarkers.

It is furthermore known to introduce activatable dye particles into the specimen, which particles can be excited to fluoresce only if they are active. For example, a subset of the dye particles in the specimen can be activated, and that subset of activated dye particles can then be excited to fluoresce. The non-activated dye particles do not react perceptibly to the excitation, and emit no fluorescent light. Methods based on these processes are called, for example, PALM or STORM. Alternatively thereto, a subset of active dye particles can be deactivated so that the remaining active dye particles can be excited to fluoresce; this is called, for example, FPALM or GIST.

Further known microscopy methods are SPIM, in which only the plane perpendicular to the detection beams is illuminated; FLIM, in which the lifetime of the excited states of the fluorescing dye particles is investigated and conclusions can be drawn therefrom as to the environment of the dye particles; FCS, in which diffusion times of bound and unbound dye particles are compared with one another; and MP, i.e. multi-photon excitation, in which individual dye particles within a very small focus are excited to fluoresce, each with the aid of two almost simultaneously absorbed photons.

DE 60 2004 005 338 T2 discloses a digital holographic microscope for three-dimensional images, and a method for using it. A specimen is illuminated using the incident- or transmitted-light method, with the result that fluorescing substances in the specimen are excited to fluoresce. The radiated fluorescent light is superimposed, with the aid of a differential interferometer, in such a way that the fluorescent light interferes with itself. The resulting interference pattern is detected with the aid of a detector. A three-dimensional image of the specimen is created on the basis of the detected light.

DE 199 08 883 A1 discloses a method for increasing the resolution of optical images. Illumination maxima and illumination minima are generated within a specimen with the aid of a diffraction grating or with multiple mirrors, so that only portions of the specimen are illuminated. Within the illuminated sub-regions, fluorescing substances are excited to fluoresce. The fluorescent light generated in this fashion is directed via an emission filter and a magnifying optical system onto an areal sensor.

WO 2006/127692 A2 describes an optical microscope having phototransformable markers. The markers are activated with the aid of activation light so that they are capable of fluorescence. The activated markers are excited to fluoresce with the aid of excitation light. The resulting fluorescent light passes through a filter and strikes a detector that detects the fluorescent light.

### SUMMARY OF THE INVENTION

The object of the invention is to create a method for investigating a specimen containing fluorescing dyes with the aid of a microscope, which method makes it possible, in simple fashion, to resolve three-dimensional structures within the specimen.

The object is achieved by the features of the independent claim 1. Advantageous embodiments are indicated in the dependent claims.

The invention is notable for the fact that the optical arrangement acts on the fluorescent light in such a way that the sub-beams of the fluorescent light interfere with themselves, so that interference patterns produced as a result of the interference are imaged on a sensitive surface of the areal sensor and sensed thereby. The positions of the dye particles within the specimen are ascertained as a function of the interference patterns.

Evaluation of the interference patterns generated by the dye particles makes it possible to determine the exact location of the dye particles in a three-dimensional volume within the specimen, with no need for displacement of mechanical components of the microscope. This contributes to the fact that while the three-dimensional resolution is high, the microscope can be of simple configuration and maintenance intervals can be extended.

Sufficiently good resolution, and thus differentiation of the individual dye particles, is preferably achieved by the fact that only a subset of the dye particles within a predefined region is excited to fluoresce. The subset, in particular the number of dye particles in the subset, is determined as a function of mutually distinguishable interference patterns. In other words, the subset excited to fluoresce is, at maximum, a number of dye particles within a predefined volume such that their interference patterns can be distinguished from one another and evaluated with the aid of the areal sensor. It is possible in this context to use activatable dye particles of which, for example, initially only a subset is activated and is then excited to fluoresce, or in which initially all dye particles are activated, then a portion of the dye particles are deactivated and the remaining subset of activated dye particles is excited to fluoresce.

Alternatively or in addition thereto, the subset of the dye particles can be determined by the fact that only dye particles within a sub-region of the specimen are excited to fluoresce. A plane within the specimen can be selected, for example, as a sub-region. The plane can be arranged so that the illumination light beam of the microscope extends perpendicular thereto, proceeds parallel to the plane, or encloses with the plane a predefined angle between 0 and 90°.

Alternatively thereto, the illumination light beam can be directed only onto individual segments of the specimen, so that only small sub-regions of the specimen are illuminated, in which sub-regions the dye particles are excited to fluoresce. A further possibility for exciting the dye particles within the plane can be achieved with the aid of multi-photon excitation.

The interference patterns can be sensed over a predefined time span, so that a change in the interference patterns is observable. On the basis of that change, conclusions can then be drawn as to movements of the dye particles within the specimen. As a function thereof, conclusions can be drawn as to moving processes within the specimen.

The dye particles excited to fluoresce have a fundamental luminescence lifetime. The luminescence lifetime represents how long the corresponding excited dye particle remains, on average, in the excited state before it transitions into the deexcited state by emitting a photon. The excited dye particles in the specimen can transfer energy to surrounding structures. The luminescence lifetime of the corresponding dye particle is thereby shortened. Observation of the luminescence lifetime of the dye particles within the specimen can thus contribute to the drawing of conclusions as to the structures surrounding the dye particles.

In addition to the observation of dye particles of one dye, dye particles of two or more further dyes can also be observed.

### BRIEF DESCRIPTION OF THE DRAWINGS

Exemplifying embodiments of the invention are further explained below with reference to schematic drawings.

In the drawings:

FIG. 1 shows a first embodiment of a microscope,

FIG. 2 is a sketch of the functional principle of the microscope,

FIG. 3 shows a second embodiment of the microscope,

FIG. 4 shows an illumination matrix of the microscope,

FIG. 5 is a flow chart of a program for operating the microscope.

Elements of identical design or function are labeled with the same reference characters throughout the Figures.

### DETAILED DESCRIPTION OF THE PREFERRED EMBODIMENTS

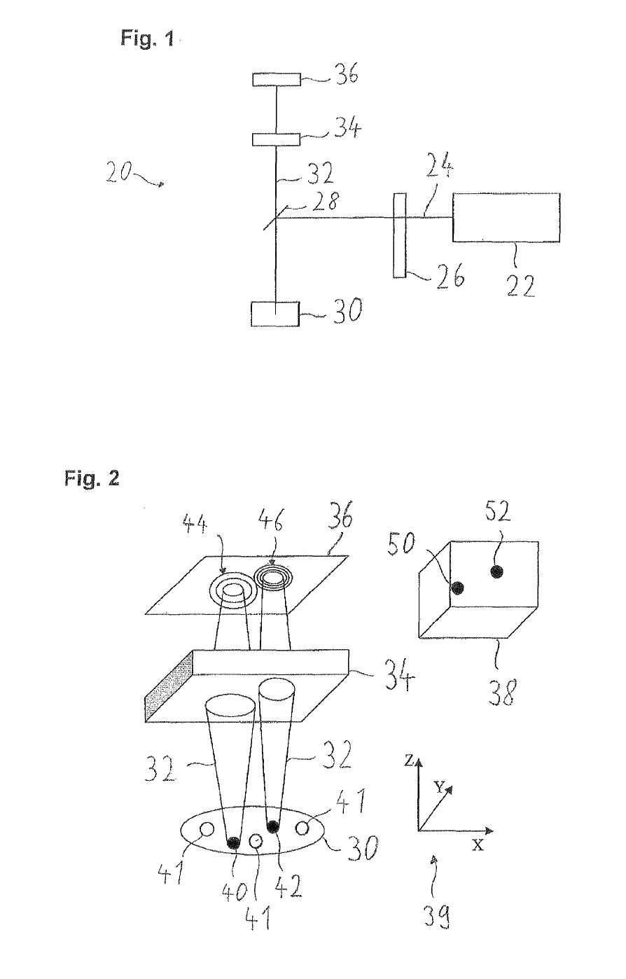

FIG. 1 shows a microscope 20. Microscope 20 is a confocal scanning microscope. Microscope 20 is in particular a fluorescence microscope. Microscope 20 encompasses a first illumination light source 22. First illumination light source 22 generates a first illumination light beam 24 that is directed via a color filter 26 onto a beam splitter 28. Beam splitter 28 reflects first illumination light beam 24 toward a specimen 30. Specimen 30 encompasses multiple dye particles that are excited to fluoresce. Fluorescent light (hereinafter called “detected light”) proceeding from specimen 30 passes through beam splitter 28, which separates the detected light from first illumination light beam 24, detected light beam 32 resulting therefrom being directed via an optical arrangement 34 onto an areal sensor 36.

The optical arrangement encompasses a diffractive optical element 34. Diffractive optical element 34 encompasses a spatial light modulator (SLM). Alternatively thereto, optical element 34 encompasses, for example, a microdisplay or an LCOS phase modulator, in particular a Fresnel zone plate or a Fresnel lens. Areal sensor 36 encompasses light-sensitive CMOS modules. Alternatively or additionally, areal sensor 36 can encompass CCD modules. First illumination light source 22 encompasses a laser. The laser is preferably a broadband laser, in particular a white light laser. Alternatively thereto, first illumination light source 22 encompasses a mercury light source, a xenon light source, or LEDs.

FIG. 2 is a sketch of the functional principle of microscope 20. A first dye particle 40 and a second dye particle 42 that are contained in specimen 30 radiate fluorescent light toward optical arrangement 34. Optical arrangement 34 acts on the fluorescent light beams in such a way that they interfere with themselves. Interference patterns occur behind optical arrangement 34 as viewed from dye particles 40, 42, and are imaged onto areal sensor 36. In particular, first dye particle 40 brings about a first ring pattern 44, and second dye particle 42 a second ring pattern 46, on the sensitive surface of areal detector 36. A virtual space that is depicted in FIG. 2 merely for explanation is not really present, and serves for visualization of an image 50 of first dye particle 40 and an image 52 of second dye particle 42. The location of images 50, 52 within virtual space 38, and thus the actual three-dimensional location of the two dye particles 40, 42 within specimen 30, is ascertained by a calculation unit of microscope 20.

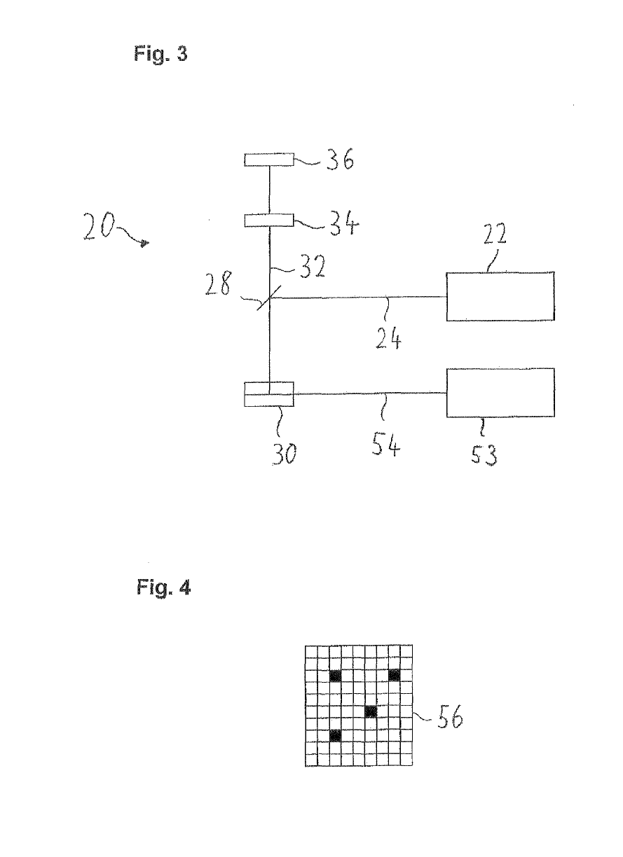

FIG. 3 shows an alternative embodiment of microscope 20. This exemplifying embodiment of microscope 20 largely corresponds to the first exemplifying embodiment of microscope 20, except only that color filter 26 has been omitted, and a second illumination light source 53 has been added in addition to first illumination light source 22. Second illumination light source 53 generates a second illumination light beam 54. Second illumination light beam 54 illuminates specimen 30 from the side, and in particular at a 90° angle to first illumination light beam 24. Second illumination light source 53 is particularly well suited for illuminating a plane within specimen 30, and thereby activating and/or exciting dye particles within the plane.

Microscope 20 in accordance with FIG. 3 can be operated in a variety of ways. For example, exclusively second illumination light beam 54 can be used to illuminate specimen 30, and first illumination light source 22 can then be omitted. Alternatively thereto, activatable dye particles within specimen 30 can be activated with one of the two illumination light beams 24, 54 and excited with another of the two illumination light beams 24, 54.

FIG. 4 shows an illumination matrix 56 of microscope 20. Illumination matrix 56 has individual cells that can be selectively illuminated with the aid of first illumination light beam 24. For example, specimen 30 can be illuminated exclusively in the regions colored black. This is achieved with the aid of the scanning microscope by scanning first illumination light beam 24 over specimen 30 and blocking out first illumination light beam 24 outside the cells that are colored black.

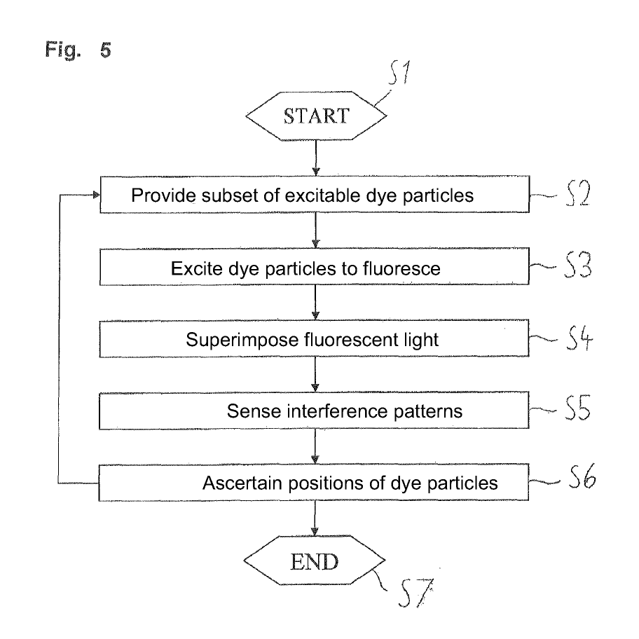

FIG. 5 shows a flow chart of a program for investigating specimen 30 containing fluorescing dyes with the aid of microscope 20. The program serves to identify a three-dimensional position of the individual dye particles 40, 42 within specimen 30, in particular without displacement of mechanical components of the microscope.

The program starts with a step S1 in which variables are initialized as applicable.

A step S2 is executed if the number of dye particles present within a predefined region of specimen 30 is such that their interference patterns are no longer differentiable. Step S2 serves merely to excite a subset of the dye particles present within a predefined region. In step S2, if activatable dye particles 40, 42 are used, a subset of the activatable dye particles is activated, or active dye particles can be deactivated so that the remaining subset of active dye particles can subsequently be excited.

In a step S3, the active dye particles 40, 42 and thus excitable dye particles 40, 42 are excited to fluoresce.

Alternatively or additionally, the subset of the dye particles can be excited by the fact that only dye particles within a plane in specimen 30 are activated and/or excited. For example, multi-photon excitation can be implemented with the aid of first illumination light source 22, so that only within the plane is the excitation probability high enough to achieve relevant excitation therein. Alternatively thereto, for example, second light source 53 can be used to excite only dye particles within a small sub-region, in particular the plane, within specimen 30. Alternatively thereto, an entire region of specimen 30 can be bleached with a high-energy radiation, so that all the fluorescing dye particles 40, 42 within the region are deactivated or destroyed. As a result of transport movements within specimen 30, active or activated dye particles are transported into the bleached region and can be excited therein. These transport processes can be observed by observing the interference patterns over a longer time span. Alternatively or additionally, specimen 30 can be selectively illuminated; for example, exclusively individual cells of illumination matrix 56 can be illuminated. Selective illumination can occur, for example, with the aid of a scanner, individually switchable LEDs, or a switchable optical arrangement, for example a switchable SLM. It is then possible in this context to read out only those data which derive from illuminated regions, thus increasing the readout rate. The data from different illuminated regions can be evaluated together (FCS).

In a step S4, the fluorescent light emitted from specimen 30 is superimposed onto itself in such a way that the individual fluorescent light beams 32 interfere with themselves.

In a step S5, the interference patterns imaged on the sensitive surface of areal sensor 36 are sensed.

In a step S6, with the aid of the calculation unit the signals of areal sensor 36 are read out and are evaluated as a function of the intensity distribution represented by ring patterns 46 and 44. In particular, in a first sub-step a center (also called a center point) of the ring pattern is ascertained. The three-dimensional location of the dye particles within specimen 30 is then ascertained on the basis of the radii of the ring patterns and on the basis of the center. Signals from a plane can be detected by the fact that their ring patterns match. A plane in specimen 30 can be established In consideration of this, and data can be obtained exclusively from that plane. In addition, data visualization can be accelerated with the aid of a feature detection or object detection function.

In a step S7, the interference pattern can be observed over a longer time span. Observation over the longer time span makes it possible to track moving dye particles 40, 42 within specimen 30, and thus to visualize moving processes within specimen 30. Alternatively or additionally, a luminescence lifetime of the fluorescing dye particles 40, 42 can be ascertained as a function of changing intensities of one of the interference patterns, providing information as to structures that surround the observed dye particles. In particular, specimen 30 is illuminated in this context with pulsed lasers having a short pulse duration. A decay process that can be observed is characteristic of the individual dye particles, and changes as a function of structures to which the dye particle is adhering. Conclusions as to the neighborhood of the individual markers can then be drawn on the basis of the decay process.

In a step S8 [not in FIG. 5] the program can be ended. Preferably, however, the program is executed regularly during the operation of microscope 20.

Observations of dye particles in all three spatial directions over a predefined time span can be used for object tracking, and thus in order to follow the dye particles within specimen 30 using an autofocus function. In addition thereto, an autofocus function alone can be implemented. It is also possible to read out 3-D data memories.

The invention is not limited to the exemplifying embodiments indicated. The invention is suitable for any microscope with which it is possible to excite a selection of fluorescing dye particles which is sufficiently small that the resulting interference patterns on the sensitive surface of areal sensor 36 is still differentiable in such a way that an evaluation allows inferences as to the exact position of the individual dye particles in specimen 30. In addition, optical element 34 can be implemented by way of a beam splitter that divides the fluorescent light into two sub-beams, a path difference between the two sub-beams then being achieved by way of further beam guidance or further optical elements. The sub-beams are subsequently combined again so that they interfere with themselves. Dye particles of different colors can moreover also be observed simultaneously.

### PARTS LIST

20 Microscope
22 First illumination light source
24 First illumination light beam
26 Color filter
28 Beam splitter
30 Specimen
32 Fluorescent light beam
34 Optical arrangement
36 Areal sensor
38 Virtual space
40 First color [sic: dye] particle
42 Second color particle
44 First ring pattern
46 Second ring pattern
50 Image of first dye particle
52 Image of second dye particle
54 Second illumination light beam
56 Illumination matrix
START Program start
END Program end
S1-S8 Steps one to eight

What is claimed is:

1. A method for investigating a specimen (30) containing fluorescing dyes with the aid of a microscope (20),
in which dye particles (40, 42) in the specimen (30) are excited to fluoresce with the aid of a first illumination light beam (24),
fluorescent light proceeding from the specimen (30) is directed via an optical arrangement (34) onto an areal sensor (36), the optical arrangement (34) acting on the fluorescent light in such a way that sub-beams of the fluorescent light interfere with themselves, so that interference patterns produced as a result of the interference are imaged on a sensitive surface of the areal sensor (36) and sensed thereby;
and in which positions of the dye particles (40, 42) within the specimen (30) are ascertained as a function of the interference patterns.

2. The method according to claim 1, in which only a selection of the dye particles (40, 42) are excited to fluoresce, and in which the selection is made as a function of the mutually distinguishable interference patterns.

3. The method according to claim 2, in which the dye particles (40, 42) can be excited to fluoresce only if they are previously activated; and in which the predefined selection of the dye particles (40, 42) is excited by the fact that only a subset of the dye particles (40, 42) is activated, and then the activated dye particles (40, 42) are excited to fluoresce with the aid of the first illumination light beam (24).

4. The method according to claim 2, in which the dye particles (40, 42) can no longer be excited to fluoresce if they are previously deactivated; and in which the predefined selection of the dye particles (40, 42) is excited by the fact that only a subset of the dye particles (40, 42) is deactivated, and then the remaining activated dye particles (40, 42) are excited to fluoresce with the aid of the first illumination light beam (24).

5. The method according to claim 2, in which the predefined selection of the dye particles (40, 42) is excited by the fact that only dye particles (40, 42) within a sub-region of the specimen are excited to fluoresce.

6. The method according to claim 5, in which a plane within the specimen (30) is illuminated as a sub-region.

7. The method according to claim 6, in which the first illumination light beam (24) extends perpendicular to the plane.

8. The method according to claim 6, in which the first illumination light beam (24) is parallel to the plane.

9. The method according to claim 6, in which the first illumination light beam (24) encloses with the plane a predefined angle between zero and ninety degrees.

10. The method according to claim 3, in which in order to activate or deactivate the dye particles (40, 42), an activation light beam is generated and is directed onto the specimen (30).

11. The method according to claim 6, in which the dye particles (40, 42) in the plane are excited to fluoresce with the aid of multi-photon excitation.

12. The method according to claim 1, in which a change in the interference patterns is sensed and evaluated; and in which a movement of the fluorescing dye particles (40, 42) within the sample (30) is ascertained as a function of the change in the interference patterns.

13. The method according to claim 12, in which a sub-region of the specimen (30) is bleached; and in which a regeneration of the sub-region, in the context of which unbleached dye particles (40, 42) travel from outside the sub-region into the sub-region, is observed on the basis of the changing interference patterns occurring as a result thereof.

14. The method according to claim 1, in which dye particles (40, 42) of two or more different dyes are simultaneously excited to fluoresce and observed.

15. The method according to claim 1, in which a decay process of the fluorescing behavior of the dye particles (40, 42) is observed,
fluorescence durations of individual dye particles (40, 42) are ascertained on the basis of the decay process; and in which properties of the environment of the corresponding dye particles (40, 42) are ascertained as a function of the fluorescence durations.
